(19) United States
(12) Patent Application Publication
(10) Pub. No.: US 2006/0125445 A1
(43) Pub. Date: Jun. 15, 2006

(54) Portable power supply with computer port

(75) Inventors: Zheng-Fang Cao, Taipei Hsien (TW); Yong-Jian Tian, Taipei Hsien (TW)

Correspondence Address: BRUCE H. TROXELL;SUITE 1404, 5205 LEESBURG PIKE, FALLS CHURCH, VA, 22401, US

(73) Assignee: Advanced Connected Inc.

(21) Appl. No.: 11/344,220

(22) Filed: Feb. 1, 2006

Related U.S. Application Data
(63) Continuation-in-part of application No. 10/920,301, filed on Aug. 18, 2004.

(30) Foreign Application Priority Data
May 5, 2004 (TW) 093112647

(51) Int. Cl. H02J 7/00

(52) U.S. Cl. 320/112

(57) ABSTRACT

A portable power supply includes a first shell, a second shell disposed on the first shell, an electronic device removably disposed in the first shell, a power supply assembly disposed in the second shell, a power indicator disposed on the second shell for displaying remaining power of the power supply assembly, a charging socket, a power socket for connecting to and supplying power to the electronic device, a computer port for communicating data between a computer and the electronic device, and a switch. The power supply assembly includes a rechargeable battery, a battery switching device, a booster circuit, a charging circuit, a battery protecting circuit, and a battery power sensing circuit.

This is a continuation-in-part of U.S. patent application Ser. No. 10/920,301, filed on Aug. 18, 2004 in the names of Zheng-Fang Cao and Yong-Jian Tian and entitled “PORTABLE POWER SUPPLY WITH COMPUTER PORT” currently pending.

### BACKGROUND OF THE INVENTION

1. Field of the Invention

The present invention relates to power supplies and more particularly to a portable, rechargeable power supply having a computer port and to such a power supply with a prolonged period of operating time per charge.

2. Description of Related Art

A wide variety of electronic products (e.g., cellular phones, PDAs (personal digital assistants), iPods, palmtops, MP3 players, etc.) are available due to the fast technological advancements. These products bring a lot of convenience to our daily life. Typically, a rechargeable battery is provided in the product. For prolonging the operating time of the product after a full charge, the manufacturers have spent much time and money in developing a battery having a larger capacity while trying to decrease the power consumption of the product. It is understood that a charger is of no use if power of the product is consumed in an outdoor environment.

U.S. Pat. No. 6,043,626 entitled “Auxiliary Battery Holder with Multicharge Functionality” disclosed a portable rechargeable battery with a prolonged period of operating time. However, the battery of the '626 patent is somewhat bulky and no provision of means for determining the remaining power of the battery. Further, no provision of port(s) thereon for communicating data between a portable electronic device connected to the battery and an external device.

U.S. Pat. No. 6,184,654 entitled “Wearable Docking-Holster System, with Energy Management, to Support Portable Electronic Devices” disclosed a bottom phone connector 40 used as a communication port of a supplemental device. Also, the bottom phone connector 40 is adapted to supply power to the supplemental device. However, power supply and signal communication cannot occur at the same time. Further, a bulky rechargeable power supply is provided in a holster 20, thereby significantly increasing size of the holster 20. This is not desirable. Furthermore, no provision of means for determining the remaining power of the battery. Thus, the need for improvement still exists.

### SUMMARY OF THE INVENTION

It is therefore an object of the present invention to provide a portable power supply comprising a first shell and a second shell disposed on a top of the first shell wherein the first shell comprises a case, a rechargeable battery in the case, and a clip formed on an underside of the case; the second shell comprises a printed circuit board (PCB), a power supply assembly, a connector device on the PCB, and a power indicator; the battery comprises two cells provided in a top and a bottom of the case respectively, either of the cells has a power cord electrically connected to a power cord of the PCB and the power supply assembly; the second shell further comprises a cover of square section and a plate; the cover comprises a plurality of apertures with the power indicator fitted thereon, a plurality of first openings formed on a rear end, and a plurality of second openings formed on one side; the plate comprises an intermediate wall, a rear wall, a region defined by the intermediate wall and the rear wall, a plurality of holes formed on the intermediate wall and the rear wall respectively, a plurality of protrusions formed on inner surfaces of the intermediate wall and the rear wall respectively, a plurality of projections formed on the plate, a plurality of blocks each formed on a base of the projection, the blocks being flush with the protrusions, and a channel on the plate; the PCB is disposed between the cover and the plate and comprises a plurality of holes with the projections inserted therethough; and the connector device comprises a first connector for charging, a second connector for supplying electric current, a third connector for communicating data, and an on/off switch.

It is another object of the present invention to provide a portable power supply comprising a first shell and a second shell disposed on a top of the first shell wherein the first shell comprises a case, a rechargeable battery in the case, and a clip formed on an underside of the case and adapted to hang on an object while carrying the power supply; the case is a parallelepiped and comprises a top surface, a bottom surface, a rectangular first hollow portion within the top surface, a rectangular second hollow portion within the bottom surface, a first opening at one end, a closed end of U-section having a second opening for permitting a connector of a cable to insert thereinto, and two sides; the battery comprises two cells provided in the first and second hollow portions respectively; either cell has a power cord electrically connected to a power cord of a printed circuit board (PCB) through a channel on the PCB for electrically interconnecting the cells and a power supply assembly on the PCB; the second shell comprises a cover of square section, the PCB, a plate, a connector device including a plurality of first, second, and third connectors on the PCB, a power indicator, and the power supply assembly; the PCB is disposed between the cover and the plate and comprises a plurality of holes; the plate comprises an intermediate wall, a rear wall, a region defined by the intermediate wall and the rear wall, a plurality of holes formed on the intermediate wall and the rear wall respectively, a plurality of protrusions formed on inner surfaces of the intermediate wall and the rear wall respectively, a plurality of projections formed on the plate and inserted through the holes for fastening the PCB, and a plurality of blocks each formed on a base of the projection, the blocks being flush with the protrusions; the cover comprises a top, a plurality of apertures formed on the top with the power indicator fitted thereon, a plurality of first openings formed on a rear end, and a plurality of second openings formed on one side wherein the first and second openings are shaped to snugly fit the first, second, and third connectors and the switch therein; the first connector is a charging socket for charging both the power supply and an electronic device by electrically connecting to an external AC (alternating current) power; the second connector is adapted to supply power from the power supply to the electronic device; the third connector is a port for communicating data with an external computer; and the switch is adapted to turn on the power supply and activate the power supply assembly for charging.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of portable power supply according to the invention;

FIG. 2 is another perspective view of the power supply with a portable electronic product mounted therein in a first operating configuration;

FIG. 3 is a further perspective view of the power supply connected to an iPod power adapter in a second operating configuration;

FIG. 4 is an exploded view of FIG. 3;

FIG. 5 is an exploded perspective view of the power supply with the cover detached;

FIG. 6 is a lengthwise sectional view of FIG. 1; and

FIG. 7 is a block circuit diagram of power supply assembly according to the invention.

### DETAILED DESCRIPTION OF THE PREFERRED EMBODIMENTS

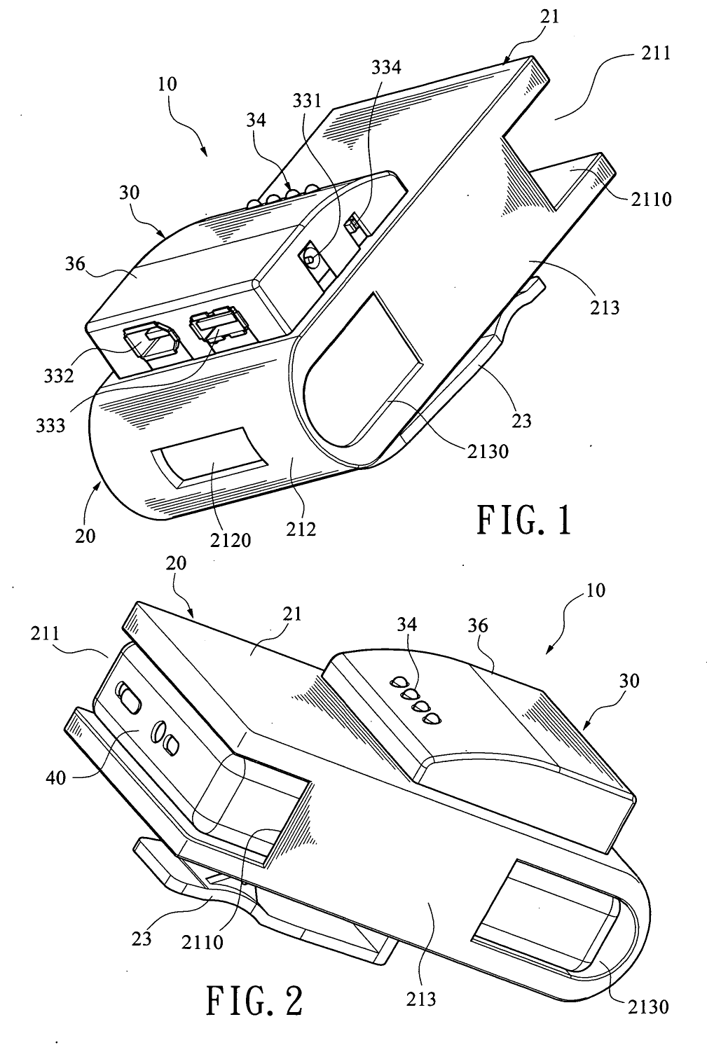

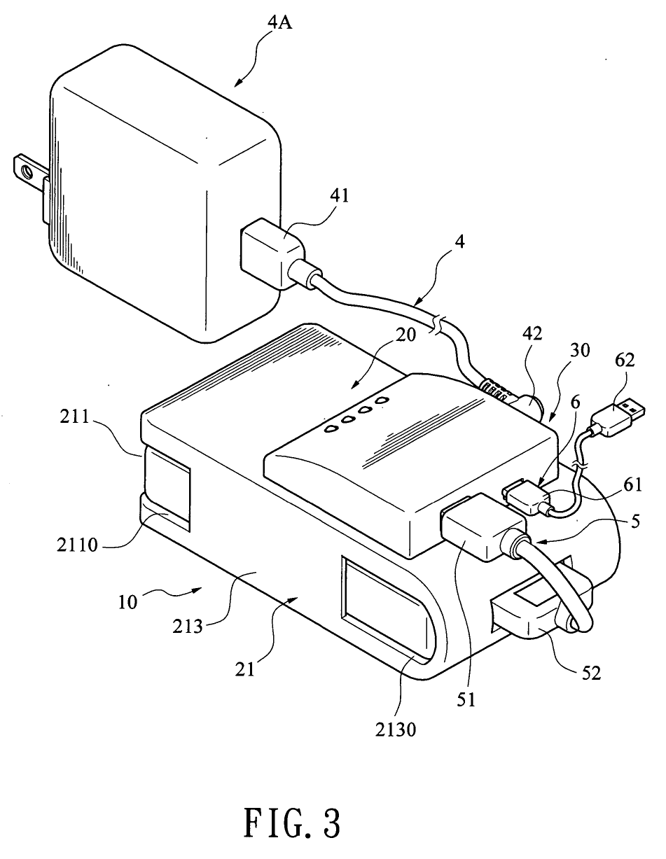

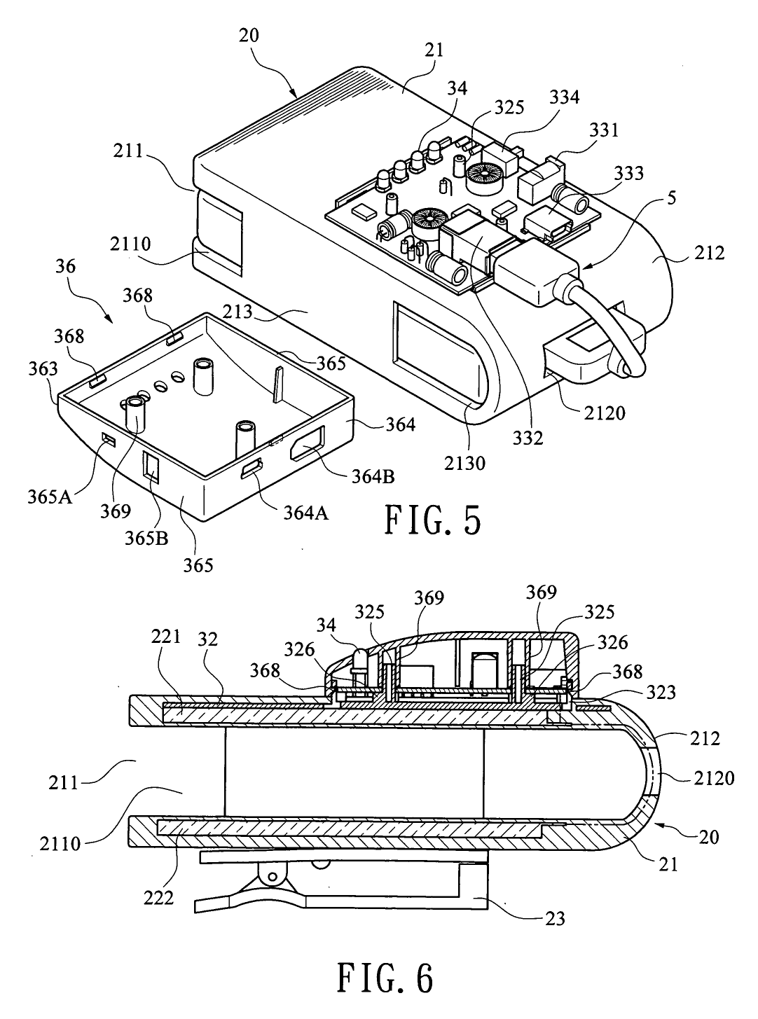

Referring to FIGS. 1 to 6, there is shown a portable power supply 10 constructed in accordance with a preferred embodiment of the invention. The power supply 10 is implemented as a housing including a main first shell 20 of parallelepiped and including a case 21, a rechargeable battery 22 in the case 21, and a clip 23 formed on an underside of the case 21 and adapted to hang on the pocket or the belt while carrying the power supply 10; and a second shell 30 including a printed circuit board (PCB) 31, a connector device 33 on the PCB 31 and including a plurality of connectors 331, 332, and 333 and a switch 334, a rectangular plate 32, a power indicator 34, and a power supply assembly 35.

The case 21 comprises a top surface 214, a bottom surface 215, a rectangular first hollow portion 2140 within the top surface 214, a rectangular second hollow portion 2150 within the bottom surface 215, a first opening 211 at one end, a closed end 212 of U section having a second opening 2120 for permitting a connector 52 of an adapter 5 to insert thereinto, and two sides 213 either having a third opening 2130 proximate the closed end 212. A first electronic device 40 is adapted to fit in the case 21. The provision of the second openings 2130 facilitates the removal of the first electronic device 40 by the hand.

The battery 22 comprises two cells 221 and 222 provided in the first and second hollow portions 2140 and 2150 respectively. Either cell 221 or 222 has a power cord 223 extended to electrically connect to a power cord 313 of the PCB 31 through a channel 327 on the plate 32. Thus, the cells 221 and 222 are electrically connected to the power supply assembly 35.

The second shell 30 is provided on the top surface 214 and comprises a cover 36 of square section, the PCB 31, and the plate 32 both provided in the cover 36. A top surface 361 of the cover 36 is curve and has a plurality of apertures 362 with a plurality of illumination members of the power indicator 34 being fitted thereon. Two fourth openings 364A and 364B are formed on a rear end 364 of the cover 36. Two fifth openings 365A and 365B are formed on one side 365 of the cover 36. The openings 364A, 364B, 365A, and 365B are shaped to snugly fit the connectors 331, 332, and 333 and the switch 334 therein. Two tabs 368 are formed on an inner surface of the front 363 of the cover 36. Two tabs 368 are formed on an inner surface of the rear 364 of the cover 36. A plurality of hollow posts 369 are formed on an underside of the top surface 361. A plurality of projections 325 are formed on the plate 32 and are adapted to insert into the posts 369. A plurality of holes 323 are formed on an intermediate wall 321 and a rear wall 322 of the plate 32 respectively and are adapted to snugly receive the tabs 368. As a result, the plate 32 and the cover 36 are fastened together.

The plate 32 and one cell 221 are fitted in the second hollow portion 2150. On a top surface of the plate 32 there are provided the intermediate wall 321, the rear wall 322, and a region 320 defined by the walls 321 and 322. A plurality of protrusions 324 are formed on inner surfaces of the intermediate wall 321 and the rear wall 322 respectively. A block 326 is formed on a base of each projection 325. The blocks 326 are flush with the protrusions 324. The projections 325 are adapted to snugly insert through holes 311 on the PCB 31 for fastening the PCB 31. The protrusions 324 and the projections 325 are served as spacers for separating the PCB 31 from the case 21 when the PCB 31 is fitted above the plate 32.

The connector 331 is a charging socket 331 for charging both the power supply 10 and the first electronic device 4 by electrically connecting to an external AC (alternating current) power through an adapter. The second connector 332 is adapted to supply power from the power supply 10 to the first electronic device 40 through a power cord. The third connector 333 is a port for communicating data with an external computer through a cable. The switch 334 is adapted to turn on the power supply 10 and activate the power supply assembly 35 for charging. Moreover, the second connector 332 has a capability of communicating data from a connected second electronic device 70 (e.g., iPod) to the third connector 333 through a circuit 312 of the PCB 31. And in turn, the third connector 333 is adapted to connect to one male plug 61 of a USB (Universal Serial Bus) connector 6. Data is eventually sent to the computer for processing through the other male plug 62 of the USB connector 6. The above described connector device 33 is only an exemplary example. It may vary in other embodiments without departing from the scope of the invention.

Referring to FIGS. 1, 3, 4, and 5 again, in the power supply 10 the first connector 331 is implemented as a DC (direct current) female jack (i.e., charging socket). A cable 4 has a connector 41 at one end adapted to connect to an iPod power adapter 4A and a male plug 42 at the other end adapted to connect to the first connector 331. As a result, external AC power is supplied to the power supply 10 for charging through the iPod power adapter 4A and the first connector 331. The second connector 332 is a 6-pin USB female connector. The adapter 5 has a 6-pin USB male plug 51 at one end adapted to connect to the second connector 332 and a 30-pin USB male plug 52 at the other end adapted to connect to an IEEE 1394 type USB female plug 71 of the second electronic device 70 through the second opening 2120. As a result, the iPod is charged by the power supply 10. Also, data in the iPod is adapted to send to the computer for processing through the connected adapter 5, the third connector 333, the circuit 312, and the USB connector 6.

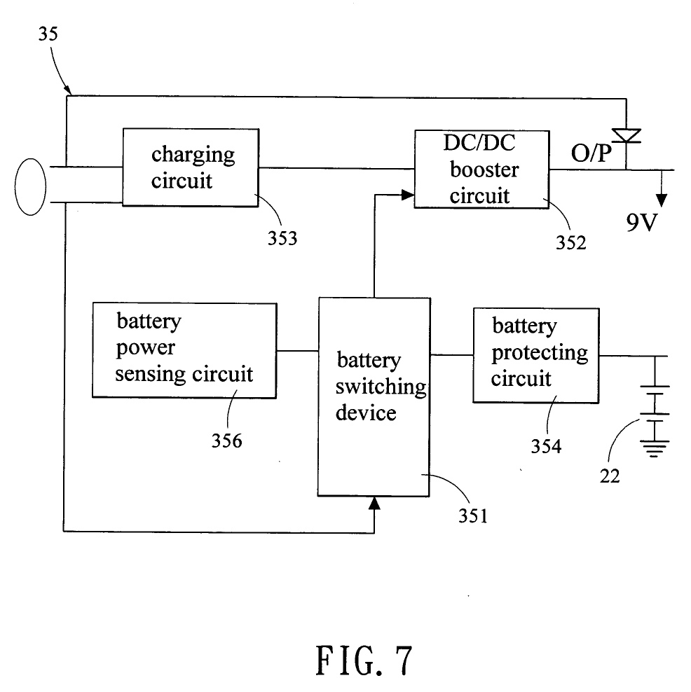

Referring to FIG. 7, the power supply assembly 35 comprises a rechargeable battery 22, a battery switching device 351, a DC/DC booster circuit 352, a charging circuit 353, a battery protecting circuit 354, and a battery power sensing circuit 356. The battery protecting circuit 354 is adapted to break the circuit when current exceeds a maximum value. The DC/DC booster circuit 352 is adapted to increase voltage to a predetermined value (e.g., 9V). The battery switching device 351 is activated by turning on the switch 334. The battery power sensing circuit 356 is adapted to sense remaining power of the battery 22 and send an indicator of the remaining power of the battery 22 to the power indicator 34. In a first charging loop, power is supplied from the battery 22 to the consumed second electronic device 70 via the battery protecting circuit 354, the battery switching device 351, and the DC/DC booster circuit 352 after turning on the switch 334 (i.e., turning on the battery switching device 351). In a second charging loop, after turning on the switch 334 (i.e., turning on the battery switching device 351) when the battery 22 is low, external AC power is fed to the charging circuit 353 and is converted into DC which is then sent to the battery 22 via the battery switching device 351 and the battery protecting circuit 354. In a third charging loop after turning on the switch 334 (i.e., turning on the battery switching device 351), DC is fed from the charging circuit 353 to the DC/DC booster circuit 352 for changing its voltage to the predetermined value (e.g., 9V) prior to supplying to the consumed battery of the second electronic device 70 directly. Note that the second charging loop, the third charging loop, or both of them can occur at the same time.

The power indicator 34 comprises a plurality of illumination members (e.g., four LEDs (light-emitting diodes)) served as a charge indicator of the battery 22. A user may turn on the switch 334 (i.e., turning on the battery switching device 351) to enable the battery power sensing circuit 356 to be energized. Next, none of the LEDs 31 are lit if the battery 22 is completely consumed, one, two, or three LEDs are lit depending on the remaining power of the battery 22, or four LEDs 31 are lit if the battery 22 is completely charged. This enables a user to easily determine the remaining power of the battery 22.

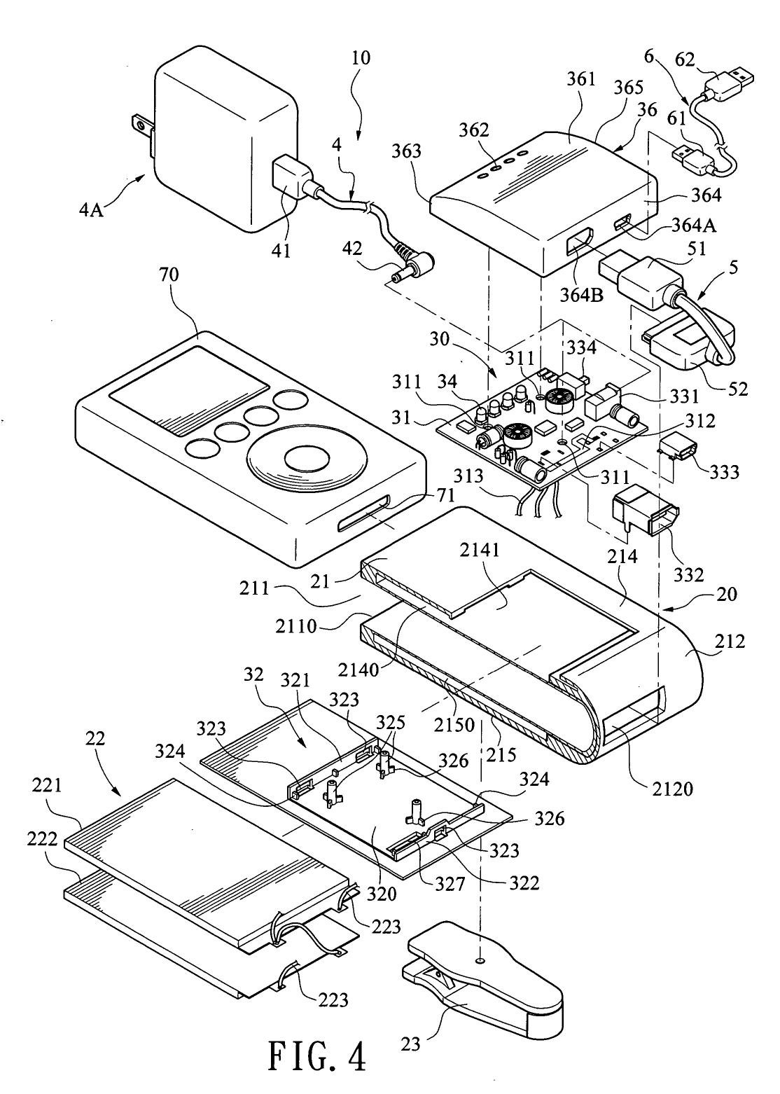

Referring to FIGS. 4, 5, and 6 again, the power supply assembly 35 comprises a plurality of ICs (integrated circuits) and a plurality of passive elements including resistors, inductors, and capacitors and is formed on the PCB 31. The power supply assembly 35 is capable of effectively controlling the battery 22 for supplying required power to the electronic devices and activating the battery power sensing circuit 356. The power supply assembly 35 is charged by connecting the iPod power adapter 4A to both the external AC power and the first connector 331.

The power supply of the invention has the following advantages: It serves as a power bank for supplying power to a connected electronic device and charging the rechargeable battery. As such, the battery is adapted to supply electric current to the electronic device when a battery installed in the electronic device is consumed. Preferably, the rechargeable battery of the invention has a capacity several times larger than that of the battery of the electronic device. Moreover, two shells are provided for receiving an electronic device and the power supply assembly respectively, thereby facilitating portability. Further, port is provided for communicating data between a connected electronic device and a computer.

While the invention herein disclosed has been described by means of specific embodiments, numerous modifications and variations could be made thereto by those skilled in the art without departing from the scope and spirit of the invention set forth in the claims.

What is claimed is:

1. A portable power supply 10 comprising:
a first shell 20 and a second shell 30 disposed on a top of the first shell 20 wherein:
the first shell 20 comprises a case 21, a rechargeable battery 22 in the case 21, and a clip 23 formed on an underside of the case 21;
the second shell 30 comprises a printed circuit board (PCB) 31, a power supply assembly 35, a connector device 33 on the PCB 31, and a power indicator 34;
the battery 22 comprises two cells 221 and 222 provided in a top and a bottom of the case 21 respectively, either of the cells 221 and 222 has a power cord 223 electrically connected to a power cord 313 of the PCB 31 and the power supply assembly 35;
the second shell 30 further comprises a cover 36 of square section and a plate 32;
the cover 36 comprises a plurality of apertures 362 with the power indicator 34 fitted thereon, a plurality of first openings 364A and 364B formed on a rear end 364, and a plurality of second openings 365A and 365B formed on one side 365;
the plate 32 comprises an intermediate wall 321, a rear wall 322, a region 320 defined by the walls 321 and 322, a plurality of holes 323 formed on the intermediate wall 321 and the rear wall 322 respectively, a plurality of protrusions 324 formed on inner surfaces of the intermediate wall 321 and the rear wall 322 respectively, a plurality of projections 325 formed on the plate 32, a plurality of blocks 326 each formed on a base of the projection 325, the blocks 326 being flush with the protrusions 324, and a channel 327 on the plate 32;
the PCB 31 is disposed between the cover 36 and the plate 32 and comprises a plurality of holes 311 with the projections 325 inserted therethough; and
the connector device 33 comprises a first connector 331 for charging, a second connector 332 for supplying electric current, a third connector 333 for communicating data, and an on/off switch 334.

2. The power supply of claim 1, wherein the first and second openings 364A, 364B, 365A, and 365B are shaped to snugly fit the first, second, and third connectors 331, 332, and 333 and the switch 334 therein.

3. A portable power supply 10 comprising:
a first shell 20 and a second shell 30 disposed on a top of the first shell 20 wherein:
the first shell 20 comprises a case 21, a rechargeable battery 22 in the case 21, and a clip 23 formed on an underside of the case 21 and adapted to hang on an object while carrying the power supply 10;
the case 21 is a parallelepiped and comprises a top surface 214, a bottom surface 215, a rectangular first hollow portion 2140 within the top surface 214, a rectangular second hollow portion 2150 within the bottom surface 215, a first opening 211 at one end, a closed end 212 of U-section having a second opening 2120 for permitting a connector 41 of a cable 4 to insert thereinto, and two sides 213;
the battery 22 comprises two cells 221 and 222 provided in the first and second hollow portions 2140 and 2150 respectively;
either cell 221 or 222 has a power cord 223 electrically connected to a power cord 313 of a printed circuit board (PCB) 31 through a channel 327 on the PCB 31 for electrically interconnecting the cells 221 and 222 and a power supply assembly 35 on the PCB 31;
the second shell 30 comprises a cover 36 of square section, the PCB 31, a plate 32, a connector device 33 including a plurality of first, second, and third connectors 331, 332, and 333 on the PCB 31, a power indicator 34, and the power supply assembly 35;
the PCB 31 is disposed between the cover 36 and the plate 32 and comprises a plurality of holes 311;
the plate 32 comprises an intermediate wall 321, a rear wall 322, a region 320 defined by the walls 321 and 322, a plurality of holes 323 formed on the intermediate wall 321 and the rear wall 322 respectively, a plurality of protrusions 324 formed on inner surfaces of the intermediate wall 321 and the rear wall 322 respectively, a plurality of projections 325 formed on the plate 32 and inserted through the holes 311 for fastening the PCB 31, and a plurality of blocks 326 each formed on a base of the projection 325, the blocks 326 being flush with the protrusions 324;
the cover 36 comprises a top 361, a plurality of apertures 362 formed on the top 361 with the power indicator 34 fitted thereon, a plurality of first openings 364A and 364B formed on a rear end 364, and a plurality of second openings 365A and 365B formed on one side 365 wherein the first and second openings 364A, 364B, 365A, and 365B are shaped to snugly fit the first, second, and third connectors 331, 332, and 333 and the switch 334 therein;
the first connector 331 is a charging socket for charging both the power supply 10 and an electronic device 40 by electrically connecting to an external AC (alternating current) power;
the second connector 332 is adapted to supply power from the power supply 10 to the electronic device 40;
the third connector 333 is a port for communicating data with an external computer; and
the switch 334 is adapted to turn on the power supply 10 and activate the power supply assembly 35 for charging.

4. The power supply of claim 3, wherein the second connector 332 is adapted to communicate data from the electronic device 40 to the computer by connecting to the third connector 333 through a circuit 312 of the PCB 31, the third connector 333 is adapted to connect to one male plug 61 of a USB (Universal Serial Bus) connector 6, and data is sent to the computer for processing through the other male plug 62 of the USB connector 6.

5. The power supply of claim 3, wherein the channel 327 is formed on the plate 32.

6. The power supply of claim 3, further comprising a plurality of tabs formed on an inner surface of a front 363 of the cover 36, a plurality of tabs 368 formed on an inner surface of a rear 364 of the cover 36, a plurality of hollow posts 369 formed on an underside of the top 361, and a plurality of projections 325 formed on the plate 32 adapted to insert into the posts 369, wherein the holes 323 are adapted to receive the tabs 368 for fastening the plate 32 and the cover 36 together.

7. The power supply of claim 3, further comprising a plurality of protrusions 324 formed on inner surfaces of the intermediate wall 321 and the rear wall 322 respectively, wherein the protrusions 324 and the projections 325 are served as spacers for separating the PCB 31 from the case 21 when the PCB 31 is fitted above the plate 32.

8. The power supply of claim 3, wherein either side 213 has a third opening 2130 proximate the closed end 212.
